(19) United States
(12) Patent Application Publication
(10) Pub. No.: US 2015/0161927 A1
(43) Pub. Date: Jun. 11, 2015

(54) DRIVING APPARATUS WITH 1:2 MUX FOR 2-COLUMN INVERSION SCHEME

(71) Applicant: INNOLUX CORPORATION, MIAO-LI COUNTY (TW)

(72) Inventor: GERBEN JOHAN HEKSTRA, MIAO-LI COUNTY (TW)

(73) Assignee: INNOLUX CORPORATION, MIAO-LI COUNTY (TW)

(21) Appl. No.: 14/097,340

(22) Filed: Dec. 5, 2013

(51) Int. Cl. G09G 3/20

(52) U.S. Cl. CPC G09G 3/20; G09G 2310/0254; G09G 2310/0297

(57) ABSTRACT

A driving apparatus comprises a plurality of pixels provided in an array employing the 2-column inversion scheme, a 1:2 multiplexer and a data driving unit. Each pixel comprises a plurality of sub-pixels corresponding to different colors respectively. The 1:2 multiplexer coupled to the two pixels multiplexes a data source over one of the sub-pixels in the m column and the other of the sub-pixels in the m+1 column of the same row corresponding to the same color and the same polarity, wherein m is positive integers. The data driving unit is coupled to the 1:2 multiplexer through a plurality of data lines and provides the data source to the 1:2 multiplexer. The data lines do not have to switch between sub-pixels, nor polarity, which is beneficial for power consumption, and for front-of screen performance, which may be influenced by artefacts caused by the switching of the multiplexer.

### BACKGROUND OF THE INVENTION

1. Field of the Invention

The instant disclosure relates to a driving apparatus; in particular, to a driving apparatus with a 1:2 mux for 2-column inversion scheme.

2. Description of Related Art

Referring to FIG. 1 showing a block diagram of a conventional driving apparatus. The conventional driving apparatus comprises a timing controller 10, a scanning driver 20, a data driver 30 and a display unit 40. The timing controller 10 controls the signal timing of the scanning driver 20 and the data driver 30. The display unit 40 comprises a plurality of pixels provided in an array, in which each pixel comprises three sub-pixels R, G and B corresponding to three primary colors, red, green and blue respectively. The scanning driver 20 is coupled to all sub-pixels of the display unit 40 through a plurality of scanning lines 201, 202 . . . and 20n. The data driver 30 is coupled to all sub-pixels of the display unit 40 through a plurality of data lines D11, D12, D13, D21, D22, D23, D31, D32, D33 . . . Dm1, Dm2 and Dm3. The display unit 40 may be a LCD or a LED display unit, in which the pixels, the scanning lines, the data lines and related switching circuits (e.g., TFTs) are usually made on a glass substrate.

High resolution displays are now developing. For example, the WQHD is a display resolution of 1440×2560 (1440RGB×2560) pixels in a 16:9 aspect ratio. It has four times as many pixels as the 720p HDTV video standard. When such displays are driven in portrait orientation (for narrow border consideration), the short line time available for charging only allows for very low multiplexing ratios of the data lines (or so-called source lines). Thus, utilized typically Mux 1:3 is already critical. This will become even more critical for larger diagonal (higher data line loading), higher frame rate, or next gen resolution (4 k). For these types of displays, we have to revert to 1:2 Mux.

The 1:2 Mux has always seemed “unnatural” for an RGB display, because it does not mesh well with the repetition of the sub-pixels. Traditionally, only multiplexer ratios of 1:3N have been employed, where one data line would sequentially address all sub-pixels of a (group of N) pixel(s).

Referring to FIG. 2 showing a dot inversion scheme of a conventional driving apparatus. The scheme exhibits a 1:2 Mux, in which the source signal of the six data lines are multiplexed to twelve sub-pixels, such as R1, G1, b1, r2, G2, B2, r3, g3, B3, R4, g4 and b4 (constituting four pixels). The scheme shown in FIG. 2 is a simple, straightforward multiplexing scheme, wherein a single data line addresses two neighboring sub-pixels of different colors. Specifically, six data lines S(6n+1), S(6n+2), S(6n+3), S(6n+4), S(6n+5) and S(6n+6) of a data driving unit 210 are connected to the switches SW1 and SW2. The first switching signal CKH1 and the second switching signal CKH2 controls the switches SW1 and SW2 respectively. When 2-column, or N×2-dot inversion is used, sub-pixels with the same polarity are grouped per data line. The data lines are multiplexed according to: S1→(R1, G1), S2→(b1, r2), S3→(G2, B2) . . . , wherein capital or small letters signify groups with the same inversion polarity. However, parasitic capacitance Cp, from fanout wiring and multiplexer TFT, dissipates power when the data line changes voltage. This has no effect for a white image (full intensity of each sub-pixel gives a white). But when uniform red (R), green (G), blue (B), cyan (C), yellow (Y), or magenta (M) images are addressed, the data line from the driver changes all the time, leading to dissipation of power. The same holds true for any image with large uniform, colored areas.

Further, another disadvantage lies within the driver itself. If individual gamma is used for R, G, and B primaries, then the driver IC must (rapidly) switch between gamma settings on each output source pin. This has consequences on the DAC design, and possibly on settling time of the DAC voltage ladder.

### SUMMARY OF THE INVENTION

The object of the instant disclosure is to offer a driving apparatus, which reduces the power consumption and improves the front-of screen performance.

In order to achieve the aforementioned objects, according to an embodiment of the instant disclosure, a driving apparatus is offered. The driving apparatus comprises a plurality of pixels, a 1:2 multiplexer and a data driving unit. The pixels are provided in an array employing the 2-column inversion scheme. Each pixel comprises a plurality of sub-pixels corresponding to different colors respectively. The 1:2 multiplexer is coupled to the two pixels. The 1:2 multiplexer multiplexes a data source over one of the sub-pixels in the m column and the other of the sub-pixels in the m+1 column of the same row corresponding to the same color and the same polarity, wherein m is positive integer. The data driving unit is coupled to the 1:2 multiplexer through a plurality of data lines and provides the data source to the 1:2 multiplexer.

In summary, the data lines of the provided driving apparatus do not have to switch between sub-pixels, nor polarity, which is beneficial for power consumption, and for front-of screen performance, which may be influenced by artefacts caused by the switching of the multiplexers.

In order to further the understanding regarding the instant disclosure, the following embodiments are provided along with illustrations to facilitate the disclosure of the instant disclosure.

### BRIEF DESCRIPTION OF THE DRAWINGS

FIG. 1 shows a block diagram of a conventional driving apparatus;

FIG. 2 shows a dot inversion scheme of a conventional driving apparatus;

FIG. 3A shows an array of a display unit with 2 column inversion according to an embodiment of the instant disclosure;

FIG. 3B shows an array of a display unit with 1×2 dot inversion according to an embodiment of the instant disclosure;

FIG. 3C shows an array of a display unit with 2×2 dot inversion according to an embodiment of the instant disclosure;

FIG. 4 shows a 2-column inversion scheme with 1:2 mux according to an embodiment of the instant disclosure;

FIG. 5 shows a 2-column inversion scheme utilizing the 1:2 multiplexer shown in FIG. 4 according to an embodiment of the instant disclosure;

FIG. 6 shows a 1:2 mux-unit according to another embodiment of the instant disclosure;

FIG. 7 shows a 2-column inversion scheme with 1:2 mux according to another embodiment of the instant disclosure;

FIG. 8 shows a 2-column inversion scheme with 1:2 mux according to another embodiment of the instant disclosure; and

FIG. 9 shows a 2-column inversion scheme with 1:2 mux according to another embodiment of the instant disclosure.

### DETAILED DESCRIPTION OF THE PREFERRED EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings.

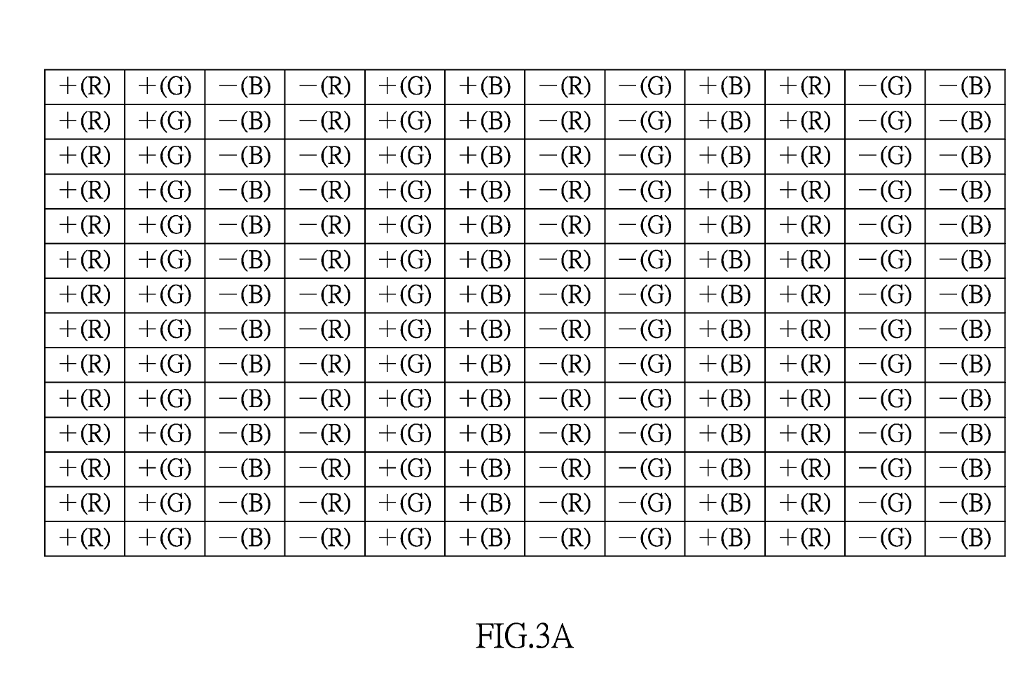

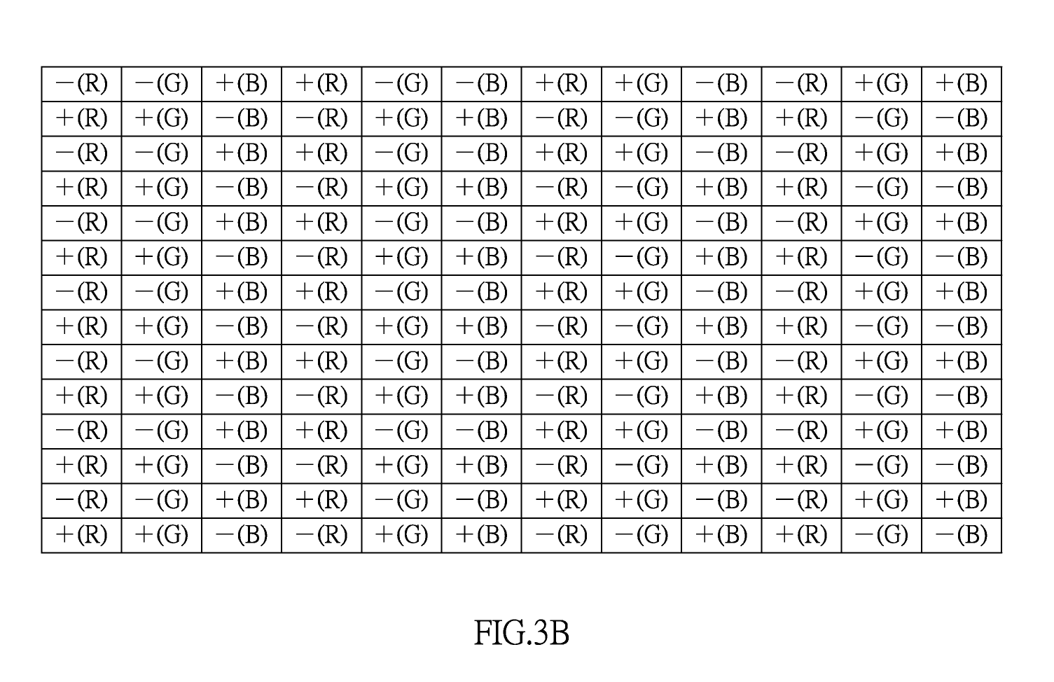

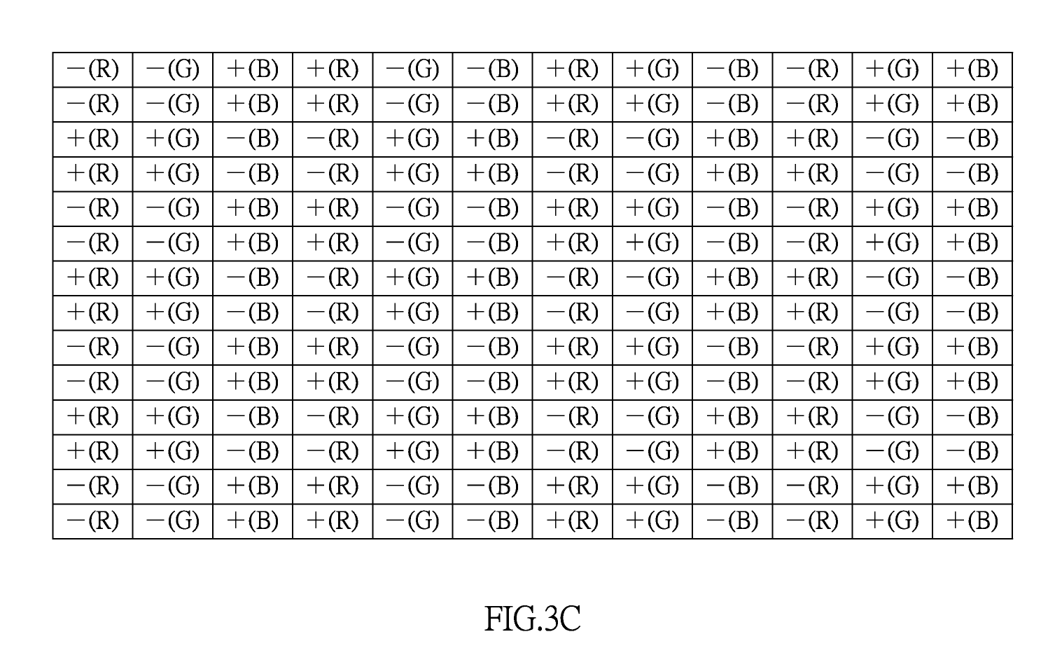

Referring to FIG. 3A showing an array of a display unit with 2-column inversion according to an embodiment of the instant disclosure. Each of the pixels of the display unit comprises a first sub-pixel, a second sub-pixel and a third sub-pixel corresponding to primary colors, and each of them can have an arbitrary intensity, from fully off to fully on. The primary colors may be red, green and blue (RGB). Alternatively, the primary colors may also corresponding to cyan, magenta and yellow respectively (CMY). The 2-column inversion scheme involves switching the polarity of voltage signals driven through data lines for every two sub-pixel columns. For example, the 2-column inversion scheme involves driving a first (e.g., positive) voltage signal to two adjacent data lines and driving a second voltage signal having an inverse (e.g., negative) polarity to the next two adjacent data lines. Other inversion modes such as 1×2 dot inversion and 2×2 dot inversion are shown in FIG. 3B and FIG. 3C respectively.

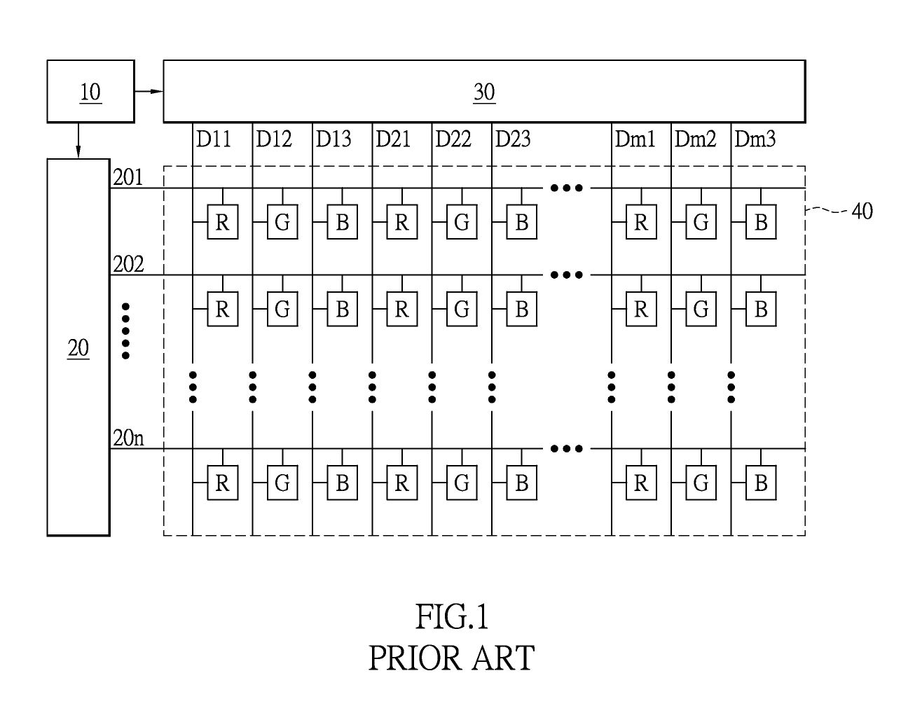

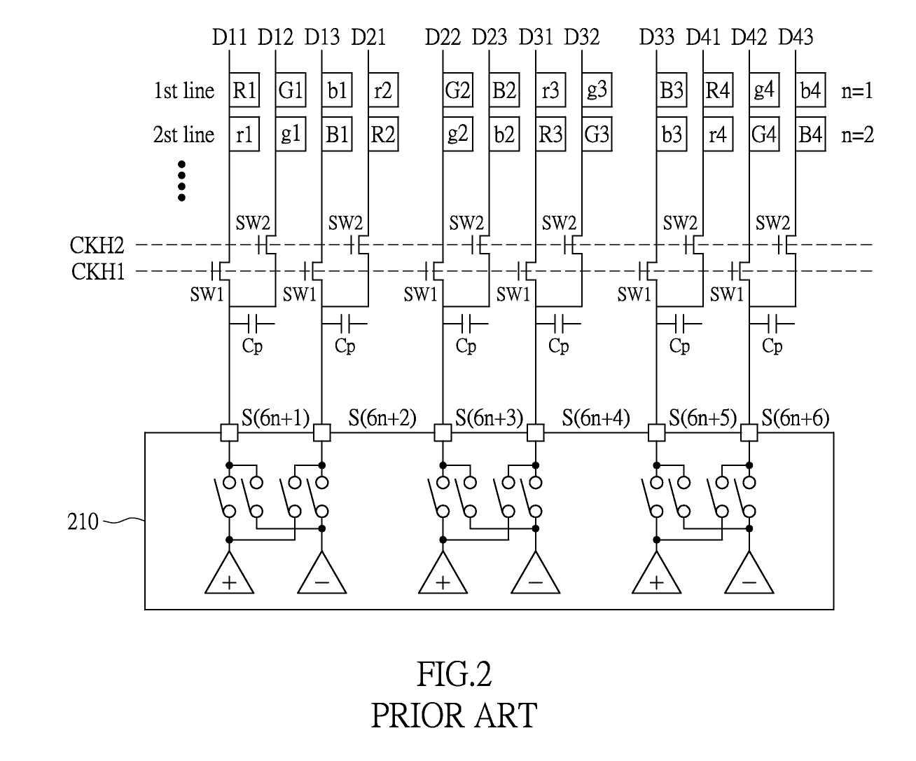

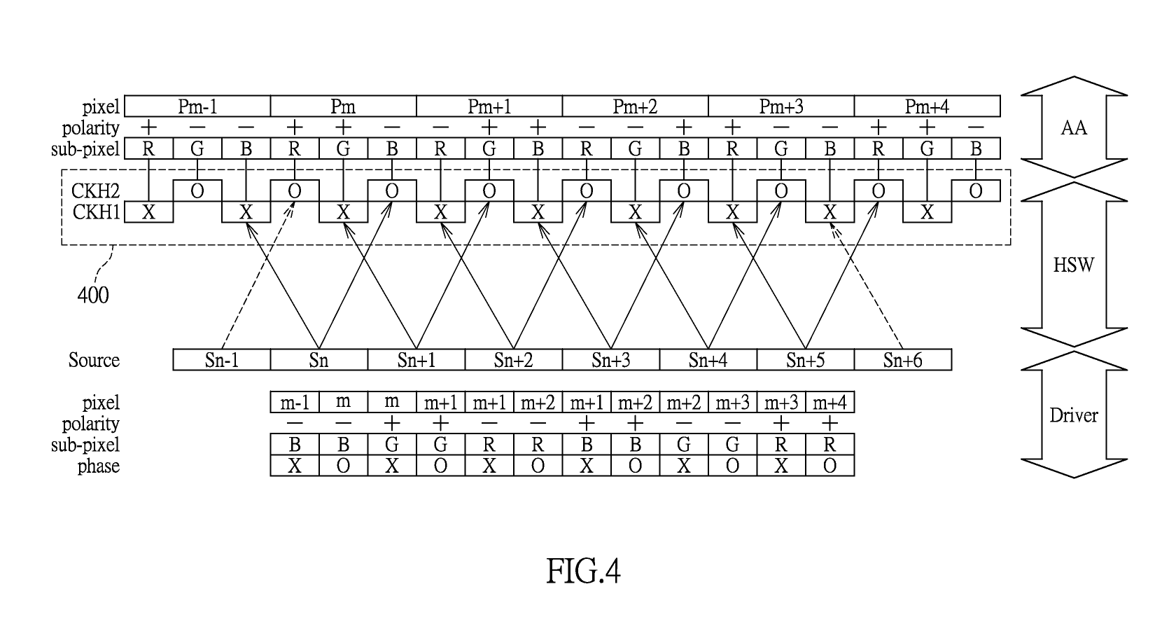

Please refer to FIG. 1 in conjunction with FIG. 4, FIG. 4 shows a 2-column inversion scheme with 1:2 mux according to an embodiment of the instant disclosure. For the active area AA of a display unit with an n×m array, in which n and m are positive integers. In each row, pixels Pm−1, Pm, Pm+1, Pm+2, Pm+3 and Pm+4 represent the pixels in the m−1 column, the m column, the m+1 column, the m+2 column, the m+3 column and the m+4 column respectively. The 1:2 multiplexer multiplexes a data source over one of the sub-pixels in the m column and the other of the sub-pixels in the m+1 column of the same row corresponding to the same color and the same polarity. In other words, a single data line is multiplexed over two closest sub-pixels, with same color, and with same polarity. For example, the data line Sn is multiplexed over the sub-pixel B of the pixel Pm−1 (through a switch indicated by “X”) and the sub-pixel B of the pixel Pm (through a switch indicated by “O”), in which the data line Sn provides the source signal corresponding to color of blue for both of two polarities. In the same way, the data line Sn+1 is multiplexed over the sub-pixel G of the pixel Pm and the sub-pixel G of the pixel Pm+1. The data line Sn+2 is multiplexed over the sub-pixel R of the pixel Pm+1 and the sub-pixel R of the pixel Pm+2. The data line Sn+3 is multiplexed over the sub-pixel B of the pixel Pm+1 and the sub-pixel B of the pixel Pm+2. The data line Sn+4 is multiplexed over the sub-pixel G of the pixel Pm+1 and the sub-pixel G of the pixel Pm+3. The data line Sn+5 is multiplexed over the sub-pixel R of the pixel Pm+3 and the sub-pixel R of the pixel Pm+4. It is worth mentioning that, in the same manner, the data line Sn−1 provides the source signal to the sub-pixel R of the pixel Pm, and the data line Sn+6 provides the source signal to the sub-pixel B of the pixel Pm+3. The connection between the signal source and the sub-pixels could be made by the multiplexer 400 (in a switching region HSW) having a plurality of switches (indicated by “O” and “X” in the middle of FIG. 4). The benefits over the 1:2 Mux design, shown in FIG. 2, is that the sub-pixels are grouped in color, as well as in polarity.

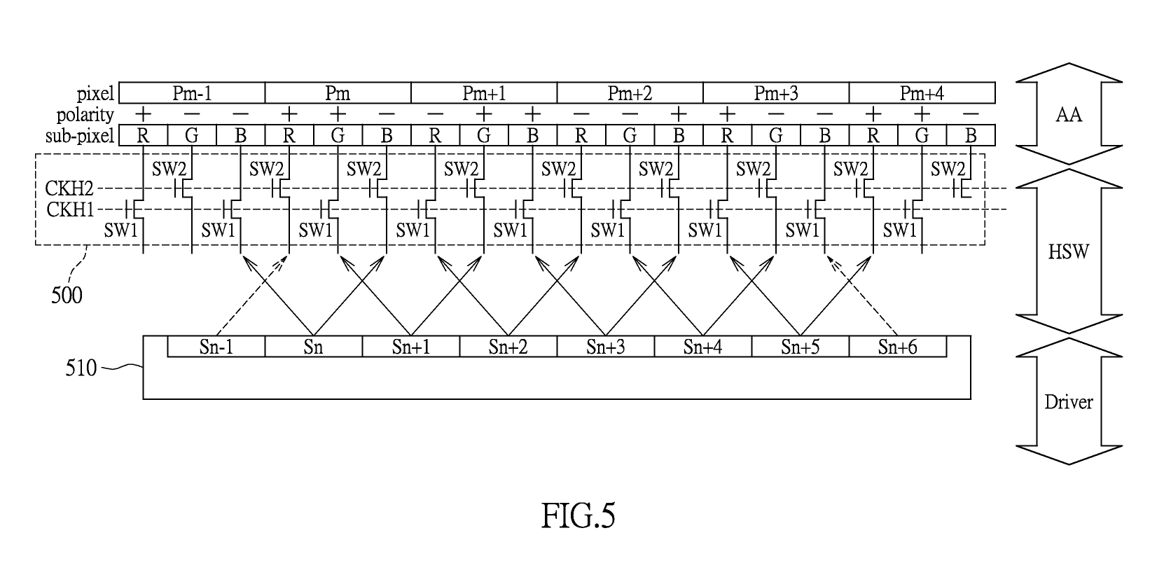

Please refer to FIG. 1 in conjunction with FIG. 5. FIG. 5 shows a 2-column inversion scheme utilizing the multiplexer 400 shown in FIG. 4 according to an embodiment of the instant disclosure. This instant disclosure provides a driving apparatus comprises a plurality of pixels Pm−1, Pm, Pm+1, Pm+2, Pm+3, Pm+4 . . . , a multiplexer 500 and a data driving unit 510. The driving apparatus may be a LCD display or a LED display, but it is not for restricting the scope of the present disclosure. The pixels (Pm−1, Pm, Pm+1, Pm+2, Pm+3, Pm+4 . . . ) are provided in an n×m array employing the 2-column inversion scheme. Each pixel (Pm−1, Pm, Pm+1, Pm+2, Pm+3 or Pm+4 . . . ) comprises three sub-pixels R, G and B corresponding to three primary colors (red, green and blue) respectively. The multiplexer 500 is coupled to the plurality pixels. The multiplexer 500 multiplexes a data source over the sub-pixels R, G and B of the pixel in the m column and the sub-pixels R, G and B of the pixel in the m+1 column of the same row corresponding to the same primary color and the same polarity, wherein m is positive integer. The data driving unit 510 is coupled to the multiplexer 500 through a plurality of data lines (Sn−1, Sn, Sn+1, Sn+2, Sn+3, Sn+4, Sn+5, Sn+6 . . . ) and provides the data source to the multiplexer 500.

The multiplexer 500 comprises a plurality of first switches SW1 and a plurality of second switches SW2. Specifically, each 1:2 multiplexer in the multiplexer 500 comprises the first switch SW1 and the second switch SW2. The first switch SW1 and the second switch SW2 may be NMOS transistors (shown in FIG. 4) or CMOS transistors, but the instant disclosure is not so restricted. The first switches SW1 are controlled by a first switching signal CKH1. The second switches SW2 are controlled by a second switching signal CKH2. In a first phase, the first switching signal CKH1 enables the first switches SW1, thus the source signal transmitted to the first switches SW1 could be delivered to the corresponding sub-pixels. In a second phase, the second switching signal CKH2 enables the second switches SW2, thus the source signal transmitted to the second switches SW2 could be delivered to the corresponding sub-pixels. Each of the first switches SW1 and each of the second switches SW2 are respectively coupling to one sub-pixel (R, G, or B) of the pixel in the m column and one sub-pixel (R, G, or B) of the pixel in the m+1 column of the same row corresponding to the same primary color and the same polarity. In detail, the data line Sn is coupled to the sub-pixel B of the pixel Pm−1 through the first switch SW1, and is coupled to the sub-pixel B of the pixel Pm through the second switch SW2. The data line Sn+1 is coupled to the sub-pixel G of the pixel Pm through the first switch SW1, and is coupled to the sub-pixel G of the pixel Pm+1 through the second switch SW2. The data line Sn+2 is coupled to the sub-pixel R of the pixel Pm+1 through the first switch SW1, and is coupled to the sub-pixel R of the pixel Pm+2 through the second switch SW2. The data line Sn+3 is coupled to the sub-pixel B of the pixel Pm+1 through the first switch SW1, and is coupled to the sub-pixel B of the pixel Pm+2 through the second switch SW2. The data line Sn+4 is coupled to the sub-pixel G of the pixel Pm+1 through the first switch SW1, and is coupled to the sub-pixel G of the pixel Pm+3 through the second switch SW2. The data line Sn+5 is coupled to the sub-pixel R of the pixel Pm+3 through the first switch SW1, and is coupled to the sub-pixel R of the pixel Pm+4 through the second switch SW2. It is worth mentioning that the overlapping of groups causes a discontinuity at the edges of the active area AA; for the scheme shown in FIG. 4 we would need to have two extra data lines, one on each end of the active area AA.

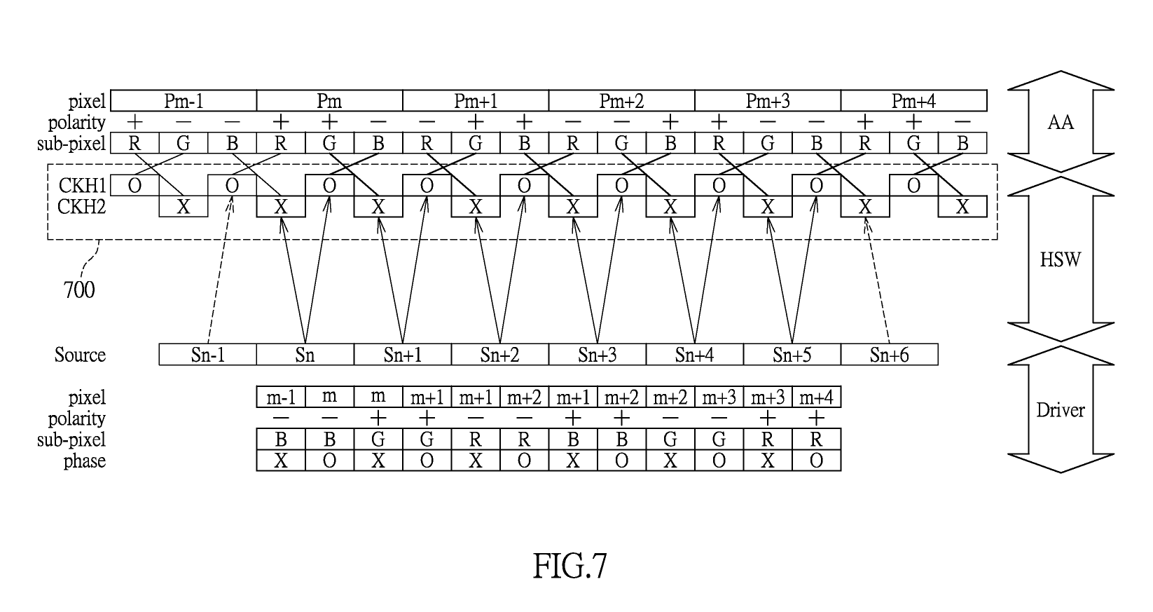

Please refer to FIG. 4 in conjunction with FIG. 7. FIG. 7 shows a 2-column inversion scheme with 1:2 mux according to another embodiment of the instant disclosure. Parts of the multiplexer circuitry shown in FIG. 4 may be spatially re-ordered, to allow for a better layout, re-use of routing layers, or greater packing density. One example of this is shown in the scheme shown in FIG. 7. Topologically, it is identical to the embodiment shown in FIG. 4, and it may have the advantage that parts of the TFT of the multiplexer 700 can be combined, leading to a more compact design. The multiplexer 700 comprises a plurality of switches indicated by “X” and a plurality of switches indicated by “O.”

Specifically, the data line Sn+1 is multiplexed over the sub-pixel G of the pixel Pm (through a switch indicated by “X”) and the sub-pixel G of the pixel Pm+1 (through a switch indicated by “O”). In the same way, the data line Sn+2 is multiplexed over the sub-pixel R of the pixel Pm+1 and the sub-pixel R of the pixel Pm+2. The data line Sn+3 is multiplexed over the sub-pixel B of the pixel Pm+1 and the sub-pixel B of the pixel Pm+2. The data line Sn+4 is multiplexed over the sub-pixel G of the pixel Pm+1 and the sub-pixel G of the pixel Pm+3. The data line Sn+5 is multiplexed over the sub-pixel R of the pixel Pm+3 and the sub-pixel R of the pixel Pm+4.

It is worth mentioning that the pixel Pm is defined as the beginning pixel in the row corresponding to the edge of the active area AA. The discontinuity at the edges of the active area AA in each row is considered in FIG. 7, and the multiplexer circuitry for the beginning/ending pixel in each row is described as follows. The three sub-pixels are defined as the first sub-pixel R, the second sub-pixel G and the third sub-pixel B arranged sequentially. On this condition, the driving apparatus further comprises a plurality of edge mux-units. Each edge mux-unit is corresponding to the beginning/ending pixels in one column of the array. For example, the pixel Pm shown in FIG. 7 is the beginning pixel, and the two switches closest to the end of the row constitute the mentioned edge mux-unit. Each edge mux-unit multiplexes the corresponding data source (for example, Sn) over the first sub-pixel (for example, R) of the beginning/ending pixel (for example, Pm) located in the beginning/ending of the row and the third sub-pixel (for example, G) of the beginning/ending pixel.

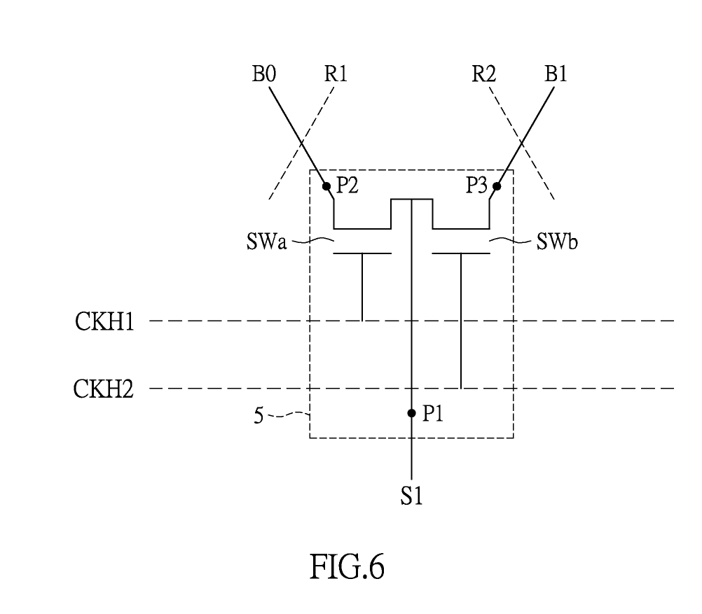

Please refer to FIG. 6 showing a 1:2 mux-unit according to another embodiment of the instant disclosure. The mux-unit 5 comprises a first switch SWa and a second switch SWb may be employed to embody the switches of the multiplexer 700 indicated by “X” and “0” controlled by the first switching signal CKH1 and the second switching signal CKH2. The mux-unit 5 comprises an input terminal P 1, a first output terminal P2 and a second output terminal P3. The input terminal P1 receives the data source from the data line. The first output terminal P2 controlled by the first switching signal CKH1 and the second output terminal P3 controlled by the second switching signal CKH2 are respectively coupling to one of the sub-pixels in the m column and the other of the sub-pixels in the m+1 column of the same row corresponding to the same color and the same polarity. For example, when the input terminal P1 of the mux-unit 5 is coupled to the source S1, the first output terminal P2 is coupled to the sub-pixel B0 of the P0 column and the second output terminal P2 is coupled to the sub-pixel B1 of the P1 column in the same row. However, this shouldn't be the limitation to the instant disclosure. The mux-unit 5 may also be embodied by other switches, such as CMOS transistors. An artisan of ordinary skill in the art will appreciate how to make an equivalent change to the mux-unit 5 shown in FIG. 6.

FIG. 7 shows a 2-column inversion scheme with 1:2 mux according to another embodiment of the instant disclosure. The mux-unit 5 shown in FIG. 6 is employed to the multiplexer 700 of the scheme shown in FIG. 7. The data source is offered by a source driver having a plurality of driving units (corresponding to the data lines Sn−1, Sn, Sn+1, Sn+2, Sn+3, Sn+4, Sn+5, Sn+6 . . . ). The driving units are in one-to-one correspondence with the mux-units. Every three driving units (Sn, Sn+1 and Sn+2) is grouped for corresponding to the pixel in the m column and the pixel in the m+1 column. Each driving unit (Sn, Sn+1 or Sn+2) provides the data source in same color to the corresponding mux-unit. The first output terminal P2 of the mux-unit 5 corresponding to the m column is connected to the third sub-pixel (B) in the m column. The second output terminal P3 of the mux-unit 5 corresponding to the m column is connected to the third sub-pixel (B) in the m−1 column, wherein the third sub-pixel in the m−1 column and the third sub-pixel in the m column are in the first polarity. For example, the first output terminal P2 of the mux-unit 5 corresponding to the m+2 column is connected to the third sub-pixel (B) in the m+2 column. The second output terminal P3 of the mux-unit 5 corresponding to the m+2 column is connected to a third sub-pixel (B) in the m+1 column. Further, the first output terminal P2 of the mux-unit 5 corresponding to the m column and the m+1 column is connected to the second sub-pixel (G) in the m+1 column. The second output terminal P3 of the mux-unit corresponding to the m column and the m+1 column is connected to the second sub-pixel (G) in the m column, wherein the second sub-pixel (G) in the m column and the second sub-pixel (G) in the m+1 column are in the second polarity. The first output terminal P2 of the mux-unit 5 corresponding to the m+1 column is connected to the first sub-pixel (R) in the n+2 column. The second output terminal P3 of the mux-unit 5 corresponding to the m+1 column is connected to the first sub-pixel (R) in the n+1 column, wherein the first sub-pixel (R) in the n+1 column and the first sub-pixel (R) in the n+2 column are in the first polarity.

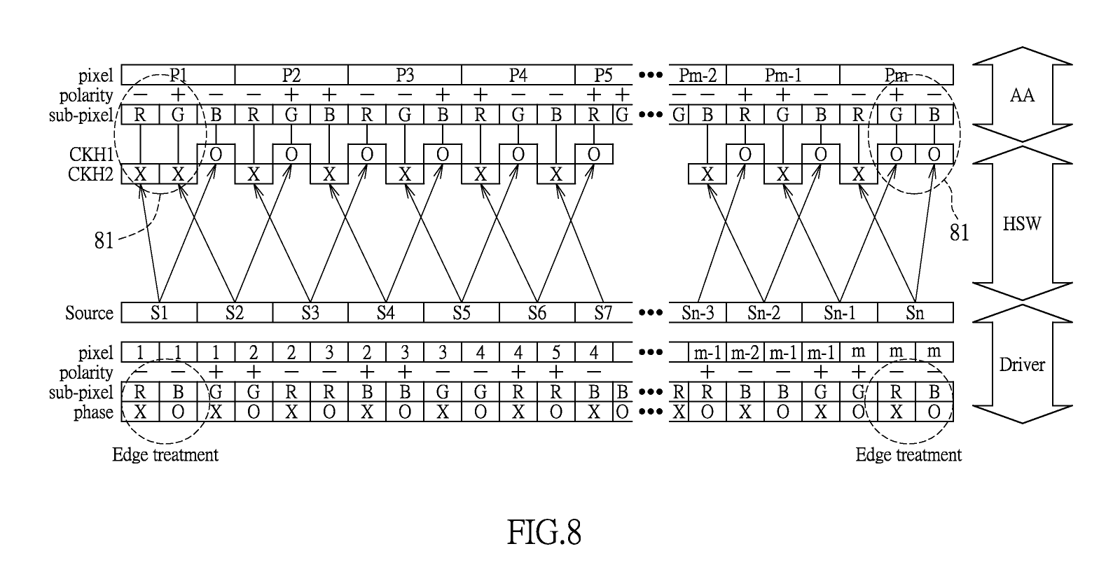

Please refer to FIG. 8 showing a 2-column inversion scheme with 1:2 mux according to another embodiment of the instant disclosure. In this embodiment, the pixel in the m column is the beginning/ending pixel as shown in FIG. 8. The driving apparatus may further comprise the edge mux-units 81. Each mux-unit 81 is corresponding to the beginning/ending pixel in one row of the array. Each edge mux-unit 81 multiplexes the corresponding data source over the first sub-pixel of the beginning/ending pixel located in the beginning/ending of the row and the third sub-pixel of the beginning/ending pixel. For example, for the beginning pixel (P1, the first pixel) of the row, a mux-unit 81 multiplexes the data source including the first sub-pixel (R) and the third sub-pixel (B), in which the first sub-pixel (R) and the third sub-pixel (B) are in the second polarity (−). For the ending pixel (Pm, the last pixel), a mux-unit 81 multiplexes the data source including the first sub-pixel (R) and the third sub-pixel (B), in which the first sub-pixel (R) and the third sub-pixel (B) are in the second polarity (−). The edge mux-unit 81 may be the same as the mux-unit 5 shown in FIG. 6, but the input/output wiring is different. Each edge mux-unit 81 comprises an input terminal P1, a first output terminal P2, a second output terminal P3, a first edge switch SWa and a second edge switch SWb. The first edge switch SWa is coupled between the input terminal P1 and the first output terminal P2. The second switch SWb is coupled between the input terminal P1 and the second output terminal P2. The input terminal P1 receives the data source, the first output terminal P2 controlled by a first switching signal CKH1 is coupled to the first sub-pixel (R) of the beginning/ending pixel in the row. The second output end P3 controlled by a second switching signal CKH2 is coupled to the third sub-pixel (B) of the beginning/ending pixel located in the beginning/ending of the row. The wiring of other mux-units corresponding to other pixels (P2, P3, P4, P5, Pm−2, Pm−1) between the beginning pixel (P1, the first pixel) and the ending pixel (Pm, the last pixel) are the same as the wiring described in FIG. 4, thus the redundant information is not repeated.

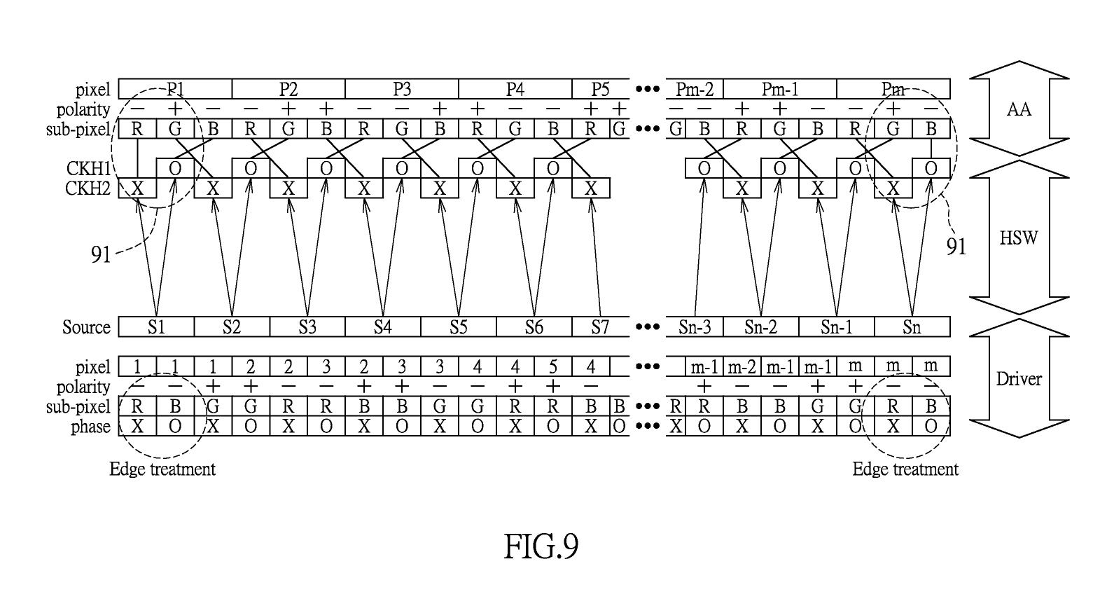

Please refer to FIG. 9 showing a 2-column inversion scheme with 1:2 mux according to another embodiment of the instant disclosure. In this embodiment, the wiring of mux-units corresponding to other pixels (P2, P3, P4, P5, Pm−2, Pm−1) between the beginning pixel and the ending pixel are the same as the wiring described in FIG. 7, thus the redundant information is not repeated. Different from the edge mux-units 81 in the scheme of FIG. 8, edge mux-units 91 are implemented for the beginning or ending pixels of the row. Similar to the mux-unit 81, each edge mux-unit 81 comprises an input terminal P1, a first output terminal P2, a second output terminal P3, a first edge switch SWa and a second edge switch SWb. For the beginning pixel P1 of the row, a mux-unit 91 multiplexes the data source including the first sub-pixel (R) and the third sub-pixel (B). For the ending pixel Pm, a mux-unit 91 multiplexes the data source including the first sub-pixel (R) and the third sub-pixel (B). However, the wiring between the third sub-pixels (B) and the second output terminal P3 of the edge mux-unit 91 corresponding to the beginning pixel P1 is different due to the arranged wiring of mux-units corresponding to other pixels (P2, P3, P4, P5, Pm−2, Pm−1) between the beginning pixel and the ending pixel. In the same way, the wiring between the first sub-pixels (R) and the first output terminal P2 is different, as shown in FIG. 9.

According to above descriptions, the provided driving apparatus employs the 2-column inversion scheme. The data lines of the provided driving apparatus do not have to switch between sub-pixels, nor polarity, which is beneficial for power consumption, and for front-of screen performance, which may be influenced by artefacts caused by the switching of the multiplexers.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A driving apparatus, comprising:
a plurality of pixels provided in an array employing the 2-column inversion scheme, each pixel comprising a plurality sub-pixels corresponding to different colors respectively;
a 1:2 multiplexer, coupled to the two pixels, the 1:2 multiplexer multiplexing a data source over one of the sub-pixels in the m column and the other of the sub-pixels in the m+1 column of the same row corresponding to the same color and the same polarity, wherein m is positive integer; and
a data driving unit, coupled to the 1:2 multiplexer through a plurality of data lines, providing the data source to the 1:2 multiplexer.

2. The driving apparatus according to claim 1, wherein the 1:2 multiplexer comprises a first switch and a second switch, the first switch are controlled by a first switching signal, the second switch are controlled by a second switching signal, the first switch and the second switch are respectively coupling to one of the sub-pixels in the m column and the other of the sub-pixels in the m+1 column of the same row corresponding to the same color and the same polarity.

3. The driving apparatus according to claim 2, wherein the first switch and the second switch are NMOS transistors or CMOS transistors.

4. The driving apparatus according to claim 1, wherein the 1:2 multiplexer comprises a plurality of mux-units, the mux-unit comprises an input terminal, a first output terminal and a second output terminal, the input terminal receives the data source from the data line, the first output terminal controlled by a first switching signal and the second output terminal controlled by a second switching signal are respectively coupling to one of the sub-pixels in the m column and the other of the sub-pixels in the m+1 column of the same row corresponding to the same color and the same polarity.

5. The driving apparatus according to claim 4, wherein the mux-unit comprises a first switch and a second switch, the first switch is coupled between the input terminal and the first output terminal, the second switch is coupled between the input terminal and the second output terminal.

6. The driving apparatus according to claim 2, wherein the data driving unit coupled to the two adjacent 1:2 multiplexer, wherein the first switch and the second switch being in one-to-one correspondence to the sub-pixels, wherein the data driving unit are the same color and the same polarity.

7. The driving apparatus according to claim 2, wherein the data driving unit coupled to the 1:2 multiplexer, wherein the first switch and the second switch being in interlaced correspondence to the two adjacent sub-pixels, wherein the data driving unit are the same color and the same polarity.

8. The driving apparatus according to claim 1, further comprising:
a plurality of edge mux-units, each edge mux-unit is corresponding to the beginning/ending pixel in one row of the array, wherein each edge mux-unit multiplexes the corresponding data source over the first sub-pixel of the beginning/ending pixel located in the beginning/ending of the row and the third sub-pixel of the beginning/ending pixel.

9. The driving apparatus according to claim 8, wherein the edge mux-unit comprises an input terminal, a first output terminal and a second output terminal, the input terminal receives the data source, the first output end controlled by a first switching signal is coupled to the first sub-pixel of the beginning/ending pixel in the row, the second output terminal controlled by a second switching signal is coupled to the third sub-pixel of the beginning/ending pixel located in the beginning/ending of the row.

10. The driving apparatus according to claim 9, wherein each edge mux-unit comprises a first edge switch and a second edge switch, the first edge switch is coupled between the input end and the first output terminal, the second switch is coupled between the input end and the second output terminal.
